(19) United States
(12) Patent Application Publication
(10) Pub. No.: US 2009/0075710 A1
(43) Pub. Date: Mar. 19, 2009

(54) GAMING APPARATUS EXECUTING RACE BY A PLURALITY OF RACE OBJECTS, AND GAME CONTROL METHOD THEREOF

(75) Inventors: Hirobumi Toyoda, Tokyo (JP); Hiroki Saito, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/185,327

(22) Filed: Aug. 4, 2008

(30) Foreign Application Priority Data
Aug. 22, 2007 (JP) 2007-216232

(51) Int. Cl. A63F 9/24; A63F 13/00

(52) U.S. Cl. 463/6

(57) ABSTRACT

A gaming apparatus of the present invention comprises: an image display; an input device with which a plurality of players can input a bet on race objects that participate in a racing game in which a plurality of race objects contend with one another for winning; and a controller, the controller programmed so as to execute the processing of (A) proceeding with a racing game, and (B) displaying to the image display an image showing information based on bets inputted from the input device before the end of the racing game executed in the processing (A).

### CROSS-REFERENCE TO RELATED APPLICATIONS

This application claims benefit of priority based on Japanese Patent Application No. 2007-216232 filed on Aug. 22, 2007. The contents of this application are incorporated herein by reference in their entirety.

### BACKGROUND OF THE INVENTION

### Field of the Invention

The present invention relates to a gaming apparatus that executes a race by a plurality of race objects, and a game control method thereof.

Conventionally, on horse racing game apparatuses, racing games have been played in which a plurality of race objects contend with one another for winning (cf. U.S. Pat. No. 6,358,150, U.S. Pat. No. 6,450,887, JP-A2001-87461, JP-B3291287, JP-B 3366308, JP-A 2002-85852, JP-A 2002-035429, U.S. Pat. No. 6,210,275, U.S. Pat. No. 6,921,331, U.S. Pat. No. 7,025,353, and U.S. Pat. No. 7,172,508). Each race object that participates in a racing game is set to win the racing game with each prescribed probability. A player who plays a game on the horse racing game apparatus predicts which race object will win in the racing game, and when the prediction proves correct, the player can receive a payout of a prescribed number of game media.

The player who plays a game on the horse racing game apparatus predicts which race object will win a racing game based on information provided from the horse racing game apparatus and the player's hunch. For example, on the conventional horse racing game apparatuses, a variety of information is provided which includes basic abilities such as speed and stamina of each race object, aptitudes showing adaptabilities of each race object to weather, a riding ground state, and a race distance, goal time in races that the race object participated in the past, and passage time at a certain furlong in the races that the race object participated in the past, and a game is played as if an actual horse racing takes place. The player then predicts which race object will win by comprehensively judging from the variety of provided information as in the case of predicting a winning horse in actual horse racing.

The contents of U.S. Pat. No. 6,358,150, U.S. Pat. No. 6,450,887, JP-A 2001-87461, JP-B 3291287, JP-B 3366308, JP-A 2002-85852, JP-A 2002-035429, U.S. Pat. No. 6,210,275, U.S. Pat. No. 6,921,331, U.S. Pat. No. 7,025,353, and U.S. Pat. No. 7,172,508 are incorporated herein by reference in their entirety.

However, in the conventional horse racing game apparatuses, since a player having a poor knowledge of horse racing does not know horse racing terms or cannot properly figure out a real meaning indicated by provided information, there have been cases where the player cannot effectively make use of the provided information. Further, an impression that horse racing is difficult has been given to such a player, causing the player to miss the chance of playing a game on the horse racing game apparatus.

Moreover, even among players having a wealth of knowledge of horse racing, some player may wish to casually enjoy a game instead of seriously making a prediction by exercising his or her brain as in actual horse racing. The conventional horse racing game apparatuses have discouraged such a player from playing a game thereon.

The present invention was made in view of the foregoing problems, and has an object to provide a gaming apparatus arranged such that any player can easily make a prediction while enjoying a game, and also a game control method of the gaming apparatus.

### SUMMARY OF THE INVENTION

In order to solve the foregoing problems, the present invention provides the following.

(1) A gaming apparatus, comprising:

an image display capable of displaying an image;

an input device with which a plurality of players can input a bet on race objects that participate in a racing game in which a plurality of race objects contend with one another for winning; and

a controller,

the controller programmed so as to execute the processing of

(A) proceeding with the racing game, and

(B) displaying to the image display an image showing information based on bets inputted from the input device before the end of the racing game executed in the processing (A).

According to the invention of (1), a gaming apparatus proceeds with a racing game in which a plurality of race objects contend with one another for winning. When bets on race objects that participate in the racing game are inputted from a plurality of players through an input device before the end of the racing game, the gaming apparatus displays to an image display an image showing information based on the bets.

Therefore, the player who plays a game on the gaming apparatus can make a prediction while using information based on other players' bets as information for making a decision. This allows any player to easily make a prediction while enjoying a game by, for example, betting on the same race object as another player as taking it that his or her prediction will prove correct, or venturing to place a bet on a different race object from those on which other players have placed bets.

Further, the present invention provides the following.

(2) The gaming apparatus according to the above-mentioned (1),

wherein

the controller is further programmed so as to execute the processing of

(C) determining a popularity ranking of each race object, based on the bets inputted from the input device, and

the processing (B) includes the processing of

(B-1) displaying to the image display an image showing the popularity ranking determined in the processing (C).

According to the invention of (2), a popularity ranking of each race object is determined based on the bets inputted from the input device. Then, an image showing the determined popularity ranking of each race object is displayed to the image display.

Therefore, the player can instantly see which race object has high popularity. Further, it is possible to make the player, who has placed a bet on a race object with its popularity ranking having increased, feel a sense of sympathy and joy.

Further, the present invention provides the following.

(3) The gaming apparatus according to the above-mentioned (2),

wherein

the controller is further programmed so as to execute the processing of

(D) counting game media bet on each race object, based on the bets inputted from the input device, and

the processing (C) is the processing of

determining a popularity ranking of each race object, based on the number of game media counted in the processing (D)

According to the invention of (3), game media bet on each race object are counted based on the bets inputted from the input device. Then, a popularity ranking of each race object is determined based on the counted number of game media. Further, an image showing the determined popularity ranking of each race object is displayed to the image display.

Therefore, the popularity ranking of each race object which has been determined based on the number of game media bet on each race object is displayed. This method for determining a popularity ranking can satisfy a genuine-article oriented player since being the same method as that in actual horse racing.

Further, the present invention provides the following.

(4) The gaming apparatus according to the above-mentioned (1),

wherein

the controller is further programmed so as to execute the processing of

(D) counting game media bet on each race object, based on the bets inputted from the input device, and

the processing (B) includes the processing of

(B-2) displaying to the image display an image showing the number of game media bet on each race object which has been counted in the processing (D).

According to the invention of (4), game media bet on each race object are counted based on the bets inputted from the input device. Then, an image showing the counted number of game media bet on each race object is displayed to the image display.

Therefore, since the very number of game media bet on each race object is displayed, the player can see the very numbers of game media bet by other players. It is then possible to make the player having seen the displayed numbers of game media feel like betting more game media than other players. As just described, it is possible to enhance a sense of rivalry of each player, so as to increase the number of game media bet per racing game.

Further, it is possible to make the player think that a race object on which many game media have been bet has a high possibility to win, and thus have an incentive to bet game media on the race object.

Further, the present invention provides the following.

(5) The gaming apparatus according to the above-mentioned (1),

wherein

the controller is further programmed so as to execute the processing of

(D) counting game media bet on each race object, based on the bets inputted from the input device, and

the processing (B) includes the processing of

(B-3) displaying to the image display an image showing a ratio of game media bet on each race object, based on the number of game media bet on each race object which has been counted in the processing (D).

According to the invention of (5), game media bet on each race object are counted based on the bets inputted from the input device. Then, an image showing a ratio of game media bet on each race object is displayed to the image display, based on the counted number of game media bet on each race object.

Therefore, since display is made in such a mode that other player's betting states are highly easy to see, it is possible to make the player easily understand information. Namely, for example, when such ratios are displayed that the numbers of game media bet on respective race objects are almost the same, it is possible to determine that the popularities of the respective race objects in the race are nearly equal, and to predict that the race will be a confused race. Further, when only a ratio of a certain race object is displayed high, it is possible to determine that the race object is popular in the race, and to predict that the race object may win an overwhelming victory.

Further, the present invention provides the following.

(6) The gaming apparatus according to the above-mentioned (1),

wherein

the controller is further programmed so as to execute processing of

(C) determining a popularity ranking of each race object, based on the bets inputted from the input device, and

(E) determining a total popularity ranking showing a popularity ranking of each race object throughout a prescribed number of racing games up to a previous racing game, based on the popularity ranking of each race object which has been determined in the processing (C), and

the processing (B) includes processing of

(B-4) displaying to the image display an image showing the total popularity ranking determined in the processing (E)

According to the invention of (6), based on a popularity ranking of each race object determined in each racing game, a total popularity ranking is determined which shows a popularity ranking of each race object throughout racing games in a prescribed number up to a previous racing game. Then, an image showing the determined total popularity ranking is displayed to the image display.

Therefore, the player who plays a game on the gaming apparatus can place a bet by taking long-term popularity rankings as information for making a decision. It is thus possible to enhance an expectation of the player for a higher possibility of making a correct prediction than in the case of referring to only the popularity ranking in a current racing game.

Further, the present invention provides the following.

(7) A game control method, including the steps of:

(A) proceeding with a racing game in which a plurality of race objects contend with one another for winning; and

(B) displaying, to an image display capable of displaying an image, an image showing information based on bets that have been inputted from an input device with which a plurality of players can input a bet, before the end of the racing game executed in the step (A), on the race objects that participate in the racing game.

According to the invention of (7), a gaming apparatus proceeds with a racing game in which a plurality of race objects contend for winning. When bets on race objects that participate in the racing game are inputted from a plurality of players through an input device before the end of the racing game, the gaming apparatus displays an image showing information based on the bets.

Therefore, the player who plays a game on the gaming apparatus can make a prediction while using information based on other players' bets as information for making a decision. This allows any player to easily make a prediction while enjoying a game by, for example, betting on the same race object as another player as taking it that his or her prediction will prove correct, or venturing to place a bet on a different race object from those on which other players have placed bets.

Further, the present invention provides the following.

(8) The game control method according to the above-mentioned (7), the method including the step of

(C) determining a popularity ranking of each race object, based on the bets inputted from the input device,

wherein

the step (B) includes the step of

(B-1) displaying to the image display an image showing the popularity ranking determined in the step (C).

According to the invention of (8), a popularity ranking of each race object is determined based on bets inputted from the input device. Then, an image showing the determined popularity ranking of each race object is displayed to the image display.

Therefore, the player can instantly see which race object has high popularity. Further, it is possible to make the player, who has placed a bet on a race object with its popularity ranking having increased, feel a sense of sympathy and joy.

Further, the present invention provides the following.

(9) The game control method according to the above-mentioned (8), the method including the step of

(D) counting game media bet on each race object, based on the bets inputted from the input device,

wherein

the step (C) is the step of

determining a popularity ranking of each race object, based on the number of game media counted in the step (D).

According to the invention of (9), game media bet on each race object are counted based on the bets inputted from the input device. Then, a popularity ranking of each race object is determined based on the counted number of game media. Further, an image showing the determined popularity ranking of each race object is displayed to the image display.

Therefore, the popularity ranking of each race object which has been determined based on the number of game media bet on each race object is displayed. This method for determining a popularity ranking can satisfy a genuine-article oriented player since being the same method as that in actual horse racing.

Further, the present invention provides the following.

(10) The game control method according to the above-mentioned (7), the method including the step of

(D) counting game media bet on each race object, based on the bets inputted from the input device,

wherein

the step (B) includes the step of

(B-2) displaying to the image display an image showing the number of game media bet on each race object which has been counted in the step (D).

According to the invention of (10), game media bet on each race object are counted based on the bets inputted from the input device. Then, an image showing the counted number of game media bet on each race object is displayed to the image display.

Therefore, since the very number of game media bet on each race object is displayed, the player can see the very numbers of game media bet by other players. It is then possible to make the player having seen the displayed numbers of game media feel like betting more game media than other players. As just described, it is possible to enhance a rivalry of each player so as to increase the number of game media bet per racing game.

Further, it is possible to make the player think that a race object on which many game media have been bet has a high possibility to win, thereby motivating the player to bet game media on the race object.

Further, the present invention provides the following.

(11) The game control method according to the above-mentioned (7), the method including the step of

(D) counting game media bet on each race object, based on the bets inputted from the input device,

wherein

the step (B) includes the step of

(B-3) displaying to the image display an image showing a ratio of game media bet on each race object, based on the number of game media bet on each race object which has been counted in the step (D).

According to the invention of (11), game media bet on each race object are counted based on the bets inputted from the input device. Then, an image showing a ratio of game media bet on each race object is displayed to the image display, based on the counted number of game media bet on each race object.

Therefore, since display is made in such a mode that other player's betting states are highly easy to see, it is possible to make the player easily understand information. Namely, for example, when such ratios are displayed that the numbers of game media bet on respective race objects are almost the same, it is possible to determine that the popularities of the respective race objects in the race are nearly equal, and to predict that the race will be a confused race. Further, when only a ratio of a certain race object is displayed high, it is possible to determine that the race object is popular in the race, and to predict that the race object may win an overwhelming victory.

Further, the present invention provides the following.

(12) The game control method according to the above-mentioned (7), the method including the step of

(C) determining a popularity ranking of each race object, based on the bets inputted from the input device,

(E) determining a total popularity ranking showing a popularity ranking of each race object throughout racing games in a prescribed number up to a previous racing game, based on the popularity ranking of each race object which has been determined in the step (C),

wherein

the step (B) includes the step of

(B-4) displaying to the image display an image showing the total popularity ranking determined in the step (E).

According to the invention of (12), based on a popularity ranking of each race object determined in each racing game, a total popularity ranking is determined which shows a popularity ranking of each race object throughout racing games in a prescribed number up to a previous racing game. Then, an image showing the determined total popularity ranking is displayed to the image display.

Therefore, the player who plays a game on the gaming apparatus can place a bet by taking long-term popularity rankings as information for making a decision. It is thus possible to enhance an expectation of the player for a higher possibility of making a correct prediction than in the case of referring to only the popularity ranking in the current racing game.

According to the present invention, it is possible to provide a gaming apparatus arranged such that any player can easily make a prediction while enjoying a game, and also a game control method of the gaming apparatus.

### BRIEF DESCRIPTIONS OF THE DRAWINGS

FIG. 1 is a view showing an example of bet information images showing information based on bets displayed to a main monitor of a horse racing game apparatus according to the present embodiment.

FIG. 2 is a perspective view schematically showing an example of the horse racing game apparatus according to the present embodiment.

FIG. 3 is a perspective view schematically showing an example of the stations shown in FIG. 2.

FIG. 4 is a block diagram showing an internal configuration of a main game portion provided in the horse racing game apparatus shown in FIG. 2.

FIG. 5 is a block diagram showing an internal configuration of a station provided in the horse racing game apparatus shown in FIG. 2.

FIG. 6 is a flowchart showing an example of game operations in the horse racing game apparatus in the present embodiment.

FIG. 7 is a view schematically showing an example of bet images displayed to a sub monitor.

FIG. 8 is flowchart showing a subroutine of popularity ranking determination processing performed in the main game portion.

FIG. 9 is a view showing an example of a previous race popularity ranking table stored in an external storage device.

FIG. 10 is a flowchart showing a subroutine of total popularity ranking determination processing performed in the main game portion.

FIG. 11 is a flowchart showing a subroutine of bet information display processing performed in the main game portion.

FIG. 12 is a flowchart showing a subroutine of a racing game execution processing performed in the main game portion.

### DESCRIPTION OF THE EMBODIMENTS

An embodiment of the present embodiment is described based on the drawings. In the following, the case of applying the present invention to a horse racing game apparatus is described as a preferred embodiment of the present invention. It is to be noted that a game in the present invention is a game totally processed by a CPU, except for input performed by a player.

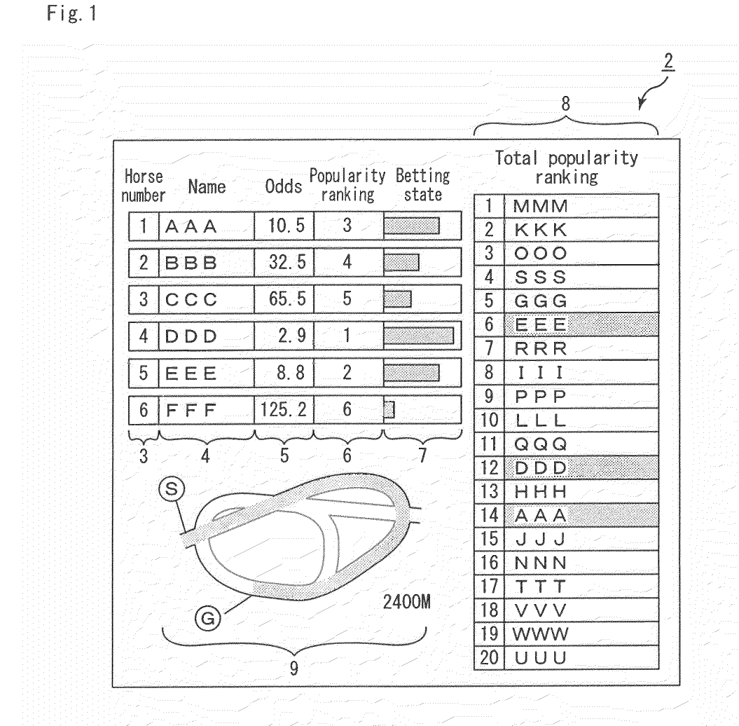

FIG. 1 is a view showing a characteristic of a horse racing game apparatus of the present embodiment, and a view showing an example of a bet information image showing information based on bets displayed to a main monitor of the horse racing game apparatus according to the present embodiment.

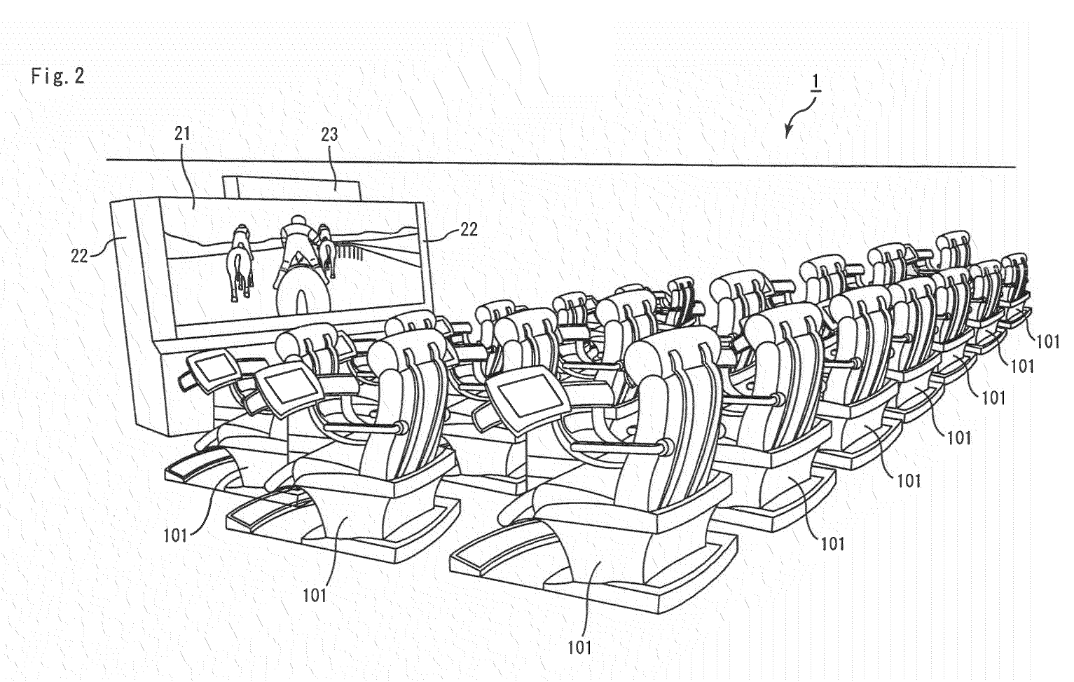

FIG. 2 is a perspective view schematically showing an example of a horse racing game apparatus according to the present embodiment.

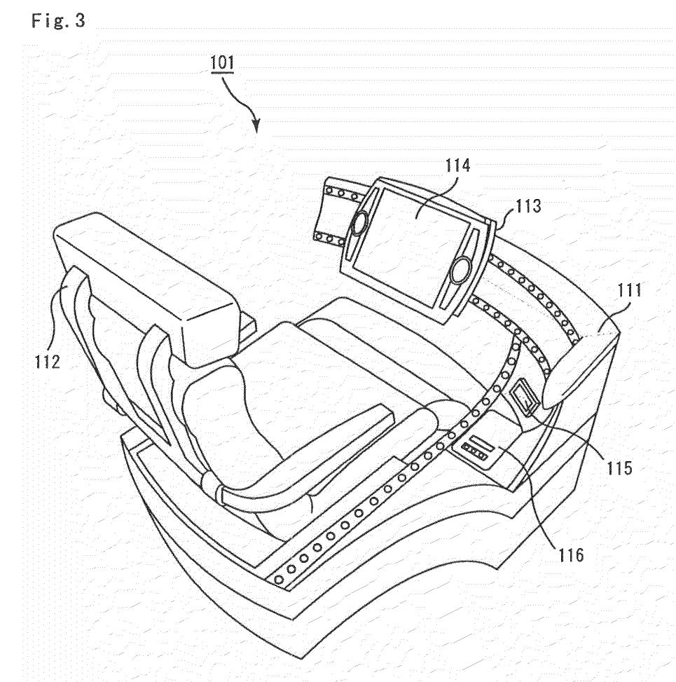

FIG. 3 is a perspective view schematically showing an example of the stations shown in FIG. 2.

As shown in FIG. 2, a horse racing game apparatus 1 according to the present embodiment includes a main monitor 21, and a plurality of stations 101 installed so as to face the main monitor 21. The player seated at each station 101 predicts a result of a racing game and inputs a bet by the use of a touch panel 114 provided on each station 101, to participate in a horse racing game.

The main monitor 21 corresponds to the image display in the present invention.

FIG. 1 is a bet information image displayed to the main monitor at the time when the player inputs a bet.

In the upper left side portion of an information image 2 shown in FIG. 1, there are provided: a horse number display region 3 that displays horse numbers indicating starting numbers of racehorses that run in a racing game (hereinafter also referred to as a “race”) in which a plurality of racehorses contend with one another for winning; a horse name display region 4 that displays names of the racehorses; an odds display region 5 that displays odds of a win betting ticket; a popularity ranking display region 6 that displays a popularity ranking; and a betting state display region 7 that displays information regarding game media having been bet.

It is to be noted that the racehorses correspond to the race objects in the present invention.

In the right-side portion of the information image 2 shown in FIG. 1, a total popularity ranking display region 8 is provided which displays a total popularity ranking indicating a popularity ranking of each racehorse throughout races in a prescribed number up to a previous race. Out of racehorses displayed in the total popularity ranking, racehorses to run in a race currently accepting bet-input are displayed in a different mode from other racehorses not to run in the race. Namely, the racehorses to run in the race are displayed so as to be easily visible by the player.

In the lower left side portion of the information image 2 shown in FIG. 1, a racecourse display region 9 is provided which displays a whole picture of a racecourse of the racing game currently accepting bet-input. Symbol S denotes a start point of the race and symbol G denotes a goal point of the race.

The images displayed in the popularity ranking display region 6, the betting state display region 7 and the total popularity ranking display region 8 correspond to the images showing information based on bets in the present invention.

FIG. 2 is a perspective view schematically showing an example of horse racing game apparatuses according to the present embodiment.

The horse racing game apparatus 1 includes: the main monitor 21; speakers 22 installed on both the right and left sides of the main monitor 21; an indicator 23 installed on a top of the main monitor 21; and the plurality of stations 101 installed so as to face the main monitor 21.

To the main monitor 21, an image showing the progress of a race, an image showing information based on bets, and the like, are displayed. From the speakers 22, a sound in accordance with the progress of the race is outputted. To the indicator 23, information regarding the game in general and the like are displayed.

It is to be noted that the station 101 corresponds to the input device in the present invention.

FIG. 3 is a perspective view schematically showing an example of the stations shown in FIG. 2.

The station 101 has: a cabinet 111, a chair 112 installed inside the cabinet 111; a sub monitor 113 installed on the cabinet 111 so as to face the chair 112; a touch panel 114 installed on the screen of the sub monitor 113; a bill validator 115 installed on the cabinet 111 to the right of the chair 112; and a ticket printer 116 installed below the bill validator 115.

To the sub monitor 113, a later-described bet image, an image showing the progress of a race, and the like, are displayed. The touch panel 114 is used when the player performs input, such as a bet operation that uses the bet image.

The bill validator 115 identifies validity of a bill, and accepts a regular bill into the cabinet 111. The bill accepted into the cabinet 111 is converted into the number of coins at a prescribed rate, and the number of credits corresponding to the number of coins is added to the number of credits owned by the player. It is to be noted that the bill validator 115 may be configured so as to be capable of reading a later-described ticket 39 with a barcode.

The ticket printer 116 prints on a ticket a barcode formed by encoding data such as the number of credits, date and time, and an identification number of the station 101, and outputs the ticket as the ticket 39 with a barcode. The player can make another station read the ticket 39 with a barcode and play a game on that station 101, or exchange the ticket 39 with a barcode with bills or the like at a prescribed place in a gaming facility (e.g. cashier booth in a casino).

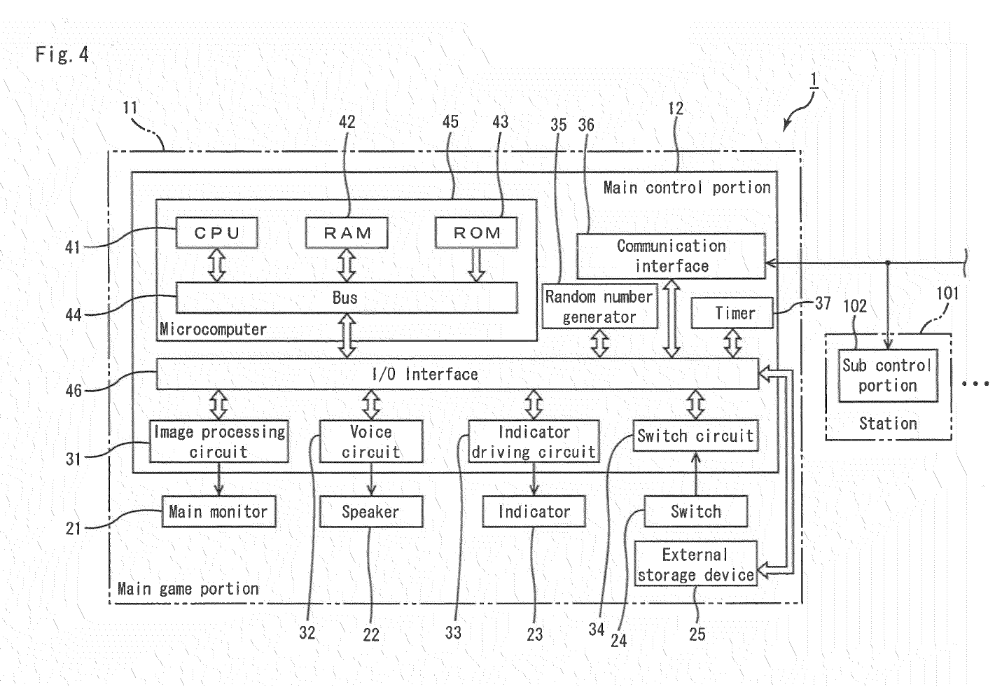

FIG. 4 is a block diagram showing an internal configuration of a main game portion provided in the horse racing game apparatus shown in FIG. 2.

A main game portion 11 is a central portion of the horse racing game apparatus 1 in the present embodiment. The main game portion 11 has a main control portion 12, the main monitor 21, the speakers 22, the indicator 23, a switch 24, and an external storage device 25.

The main control portion 12 has a microcomputer 45, arranged on a circuit board, as a main constituent. The microcomputer 45 has a CPU 41 that performs a control operation in accordance with a previously set program, a RAM 42, and a ROM 43.

The RAM 42 is a memory for temporarily storing a variety of data computed in the CPU 41. The ROM 43 stores a variety of programs for performing processing necessary in controlling the horse racing game apparatus 1, information regarding a plurality of racehorses, data on winning percentage of each racehorse, and the like.

The microcomputer 45 is connected with an image processing circuit 31 through an I/O interface 46. The image processing circuit 31 is connected to the main monitor 21, and controls the drive of the main monitor 21.

The image processing circuit 31 has a program ROM 311, an image ROM 312, an image control CPU 313, a work RAM 314, an image data processor 315 (hereinafter also referred to as a “VDP 315”), and a video RAM 316.

The program ROM 311 stores a program for image control regarding display within the main monitor 21, and a variety of selection tables.

Further, the image ROM 312 stores, for example, dot data for forming an image within the main monitor 21 and a variety of image data such as background image data and image data of racehorses.

Further, the image control CPU 313 determines an image to be displayed to the main monitor 21 out of the dot data and image data previously stored inside the image ROM in accordance with the image control program previously stored inside the program ROM, based on a parameter set in the microcomputer 45.

Further, the work RAM 314 is configured as a temporary storage unit in execution of the image control program in the image control CPU 313.

Furthermore, the VDP 315 generates image data in accordance with display contents determined in the image control CPU 313, and outputs the data to the main monitor 21.

Moreover, the video RAM 316 is configured as a temporary storage unit in formation of an image in the VDP 315.

The microcomputer 45 is connected with a voice circuit 32 through the I/O interface 46. The voice circuit 32 is connected with the speakers 22. The speakers 22 are provided on the right and left sides of the main monitor 21, and output a sound under output-control by the voice circuit 32, based on a drive signal from the CPU 41.

The microcomputer 45 is connected with an indicator driving circuit 33 through the I/O interface 46. The indicator driving circuit 33 is connected with the indicator 23. The indicator 23 is provided on the top of the main monitor 21, and displays information regarding a game in general, and the like, under display-control by the indicator driving circuit 33, based on a drive signal from the CPU 41.

The microcomputer 45 is connected with a switch circuit 34 through the I/O interface 46. The switch circuit 34 is connected with the switch 24. The switch 24 is provided below the main monitor 21, and inputs a command by a setting operation performed by an operator into the CPU 41, based on a switch signal from the switch circuit 34.

The microcomputer 45 is connected with a random number generator 35 through the I/O interface 46. The random number generator 35 generates a random number to be sampled by the CPU 41.

The microcomputer 45 is connected with a timer 37 through the I/O interface 46. The timer 37 is used for measuring time at the start of a racing game, and the like.

The microcomputer 45 is connected with the external storage device 25 through the I/O interface 46. The external storage device 25 is provided on the periphery of the main monitor 21. The external storage device 25 stores, for example, a later-described previous race popularity ranking table.

Further, for example, storing the dot data for forming an image and the like into the external storage device 25 allows the external storage device 25 to have a function similar to that of the image ROM 312 inside the image processing circuit 31. Therefore, when determining an image to be displayed to the main monitor 21, the image control CPU 313 inside the image processing circuit 31 also takes the dot data and the like previously stored inside the external storage device 25 as objects for the determination.

The microcomputer 45 is connected with the communication interface 36 through the I/O interface 46. The communication interface 36 is connected with a sub control portion 102 of each of the stations 101. Therefore, the CPU 41 transmits and receives a command, a request, data, and the like, to and from each of the stations 101 through the communication interface 36.

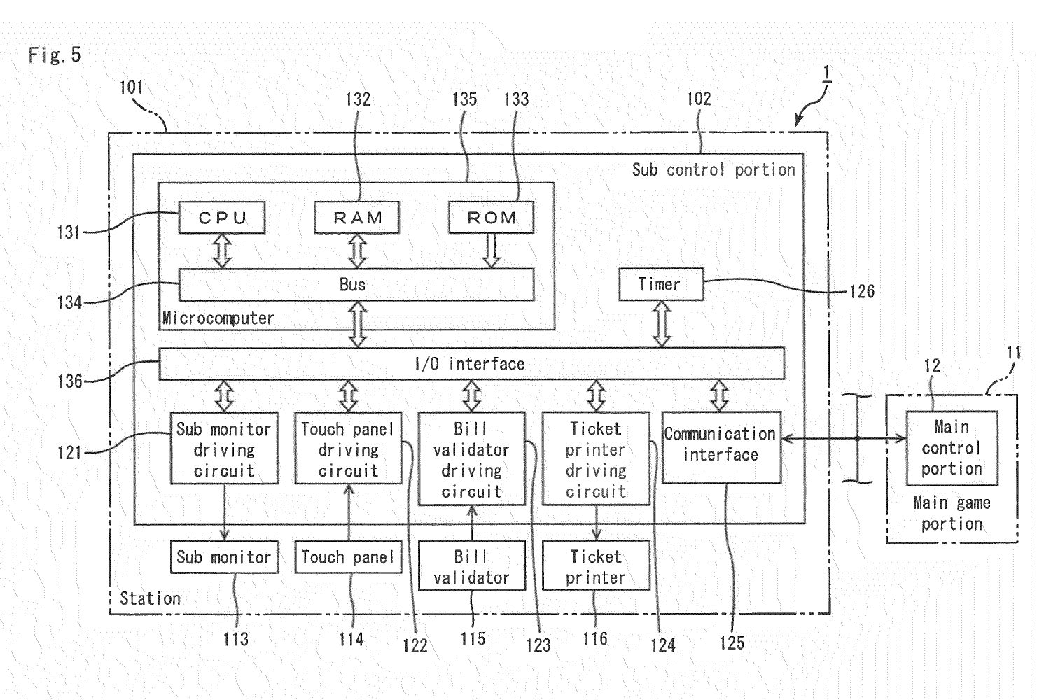

FIG. 5 is a block diagram showing an internal configuration of the station provided in the horse racing game apparatus shown in FIG. 2.

The station 101 includes the sub control portion 102, the sub monitor 113, the touch panel 114, the bill validator 115, and the ticket printer 116.

The sub control portion 102 has a microcomputer 135 arranged on the circuit board, as a main constituent. The microcomputer 135 has a CPU 131 that performs a control operation in accordance with a previously set program, a RAM 132, and a ROM 133.

The RAM 132 is a memory for temporarily storing a variety of data computed in the CPU 131. The ROM 133 stores a variety of programs for performing processing necessary in controlling the horse racing game apparatus 1, a data table, and the like.

The microcomputer 135 is connected with a sub monitor driving circuit 121 through an I/O interface 136. The sub monitor driving circuit 121 is connected with the sub monitor 113. The sub monitor driving circuit 121 controls the drive of the sub monitor 113, based on a drive signal from the main game portion 11. The sub monitor driving circuit 121 has a configuration and function similar to those of the image processing circuit 31, and for example, controls the drive of the sub monitor 113 so that a later-described bet image is displayed.

The microcomputer 135 is connected with a touch panel driving circuit 122 through the I/O interface 136. The touch panel driving circuit 122 is connected with the touch panel 114. The touch panel 114 is provided on the screen of the sub monitor 113, and inputs into the CPU 131 a command by a touching operation of the player as a coordinate signal from the touch panel driving circuit 122.

The microcomputer 135 is connected with a bill validator driving circuit 123 through the I/O interface 136. The bill validator driving circuit 123 is connected with the bill validator 115. The bill validator 115 identifies validity of a bill and the ticket 39 with a barcode. When accepting a regular bill, the bill validator 115 inputs the amount of the accepted bill into the CPU 131, based on an identification signal from the bill validator driving circuit 123. Further, when accepting a regular ticket 39 with a barcode, the bill validator 115 inputs into the CPU 131 the number of credits and the like which are recorded on the ticket 39 with a barcode, based on an identification signal from the bill validator driving circuit 123.

The microcomputer 135 is connected with a ticket printer driving circuit 124 through the I/O interface 136. The ticket printer driving circuit 124 is connected with the ticket printer 116. The ticket printer 116 prints on a ticket a barcode formed by encoding data such as the number of owned credits stored in the RAM 132, and the like, and outputs the ticket as the ticket 39 with a barcode under output-control by the ticket printer driving circuit 124, based on a drive signal outputted from the CPU 131.

The microcomputer 135 is connected with a communication interface 125 through the I/O interface 136. The communication interface 125 is connected with the main control portion 12 of the main game portion 11. Therefore, the CPU 131 transmits and receives a command, a request, data, and the like, to and from the main game portion 11 through the communication interface 125.

The microcomputer 135 is connected with the timer 126 through the I/O interface 136. The timer 126 is used for measuring time in ending acceptance of the bet operation.

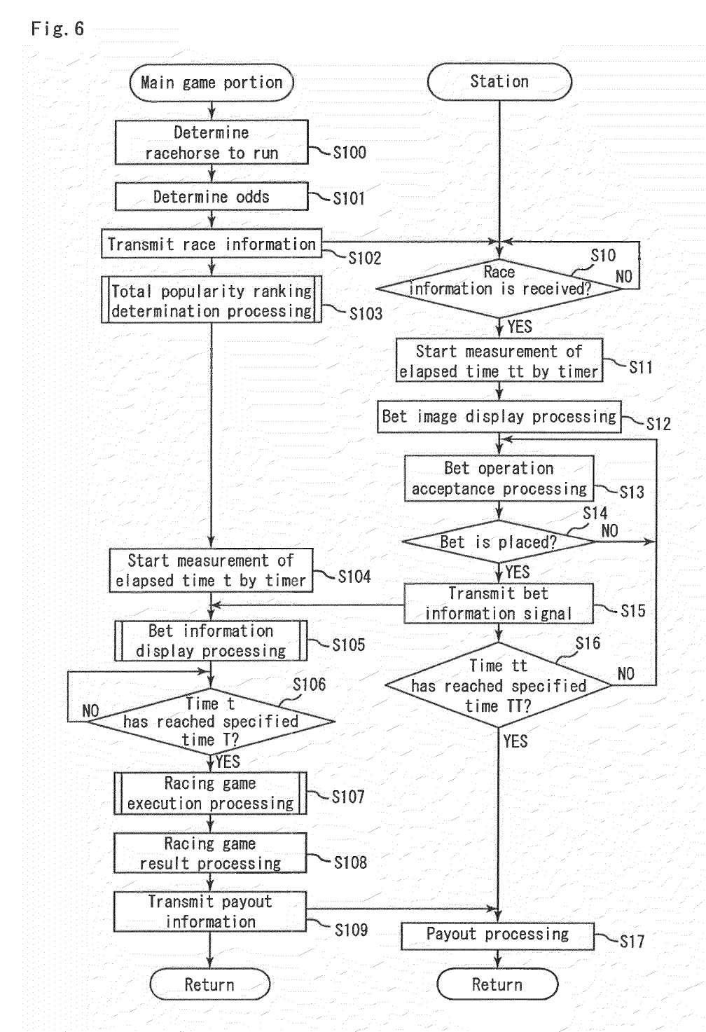

FIG. 6 is a flowchart showing an example of game operations in the horse racing game apparatus in the present embodiment.

It is to be noted that FIG. 6 shows only processing performed in one station 101 for the sake of avoiding complexity.

In the main game portion 11, respective operations of steps S100 to S109 are performed.

First, in step S100, the CPU 41 selects information regarding a prescribed number of (e.g. 6) racehorses out of information regarding a plurality of racehorses stored in the ROM 43, based on random numbers generated by the random number generator 35, and determines those horses as racehorses to run in a race this time around. At this time, the CPU 41 provides starting numbers of “1” to “6” to the racehorses to run.

Next, in step S101, the CPU 41 executes processing of determining odds per betting ticket system. At this time, the CPU 41 sets odds, based on winning percentage data of each racehorse which is stored in the ROM 43. Therefore, order-of-finish prediction odds including a racehorse with a high winning probability are set low, whereas order-of-finish prediction odds including a racehorse with a low winning probability are set high.

In step S102, the CPU 41 transmits, to each station 101, race information on the racehorses to run and odds which have been determined in the processing of steps S100 and S101.

In step S103, the CPU 41 determines a total popularity ranking by total popularity ranking determination processing.

In this total popularity ranking determination processing, the CPU 41 determines a total popularity ranking of each racehorse, based on an average popularity ranking of each racehorse in past 50 racing games.

This total popularity ranking determination processing is detailed later using a drawing.

Next, in step S104, the CPU 41 starts measuring elapsed time t by the timer 37.

In step S105, the CPU 41 controls the VDP 315, to execute bet information display processing.

In this bet information display processing, the CPU 41 controls the VDP 315 so as to output to the main monitor 21 an image showing the total popularity ranking, names of the racehorses to run, and odds, which have been determined in the processing of steps S100, S101 and S103. Further, the CPU 41 controls the VDP 315 so as to output to the main monitor 21 an image showing the number of existing bets on each racehorse and the popularity ranking thereof stored in the RAM 42.

This bet information display processing is detailed later using a drawing.

Next, in step S106, the CPU 41 determines whether or not the elapsed time t measured by the timer 37 has reached previously-set specified time T (e.g. 60 seconds). When determining that the elapsed time t has not reached the specified time T, the CPU 41 returns the processing to step S106. On the other hand, when determining that the elapsed time t has reached the specified time T, the CPU 41 shifts the processing to step S107.

In step S107, the CPU 41 executes racing game execution processing.

In this racing game execution processing, the CPU 41 determines an order of finish of each racehorse in the racing game, based on a random number generated by the random number generator 35. The CPU 41 then controls the VDP 315, to output an image showing the race progress to the main monitor 21, based on the determined order of finish of each racehorse.

This racing game execution processing is detailed later using a drawing.

In step S108, the CPU 41 calculates an amount of payout for each station 101, based on the order of finish of each racehorse which has been determined in the racing game execution processing of step S107 and on a bet information signal transmitted from each station 101 in later-described processing of step S15.

Next, in step S109, the CPU 41 transmits each of the amounts of payout calculated in the processing of step S108 as payout information to each corresponding station 101.

Hereafter, the same processing is repeated in subsequent races.

Meanwhile, in each of the stations 101, respective operations of steps S10 to S17 are performed.

First, in step S10, the CPU 131 determines whether or not race information has been received from the main game portion 11. When determining that the information has not been received, the CPU 131 returns the processing to step S10. On the other hand, when determining that the information has been received, the CPU 131 shifts the processing to step S11.

In step S11, the CPU 131 starts measuring elapsed time tt by the timer 126.

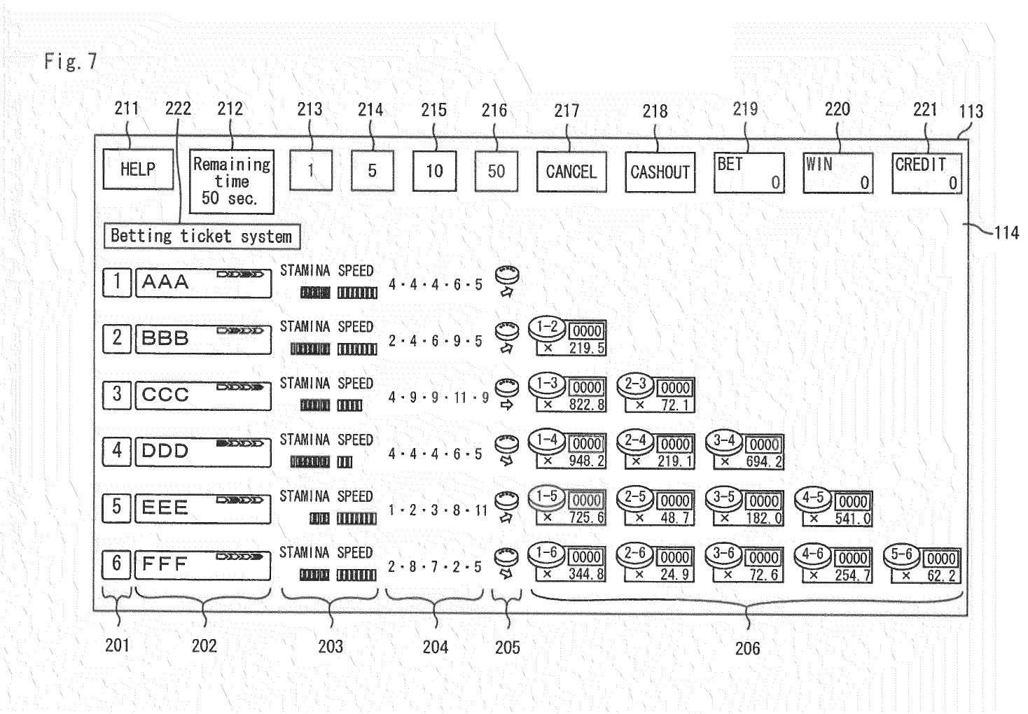

In step S12, the CPU 131 displays a bet image to the sub monitor 113, based on the race information transmitted from the CPU 41. FIG. 7 shows an example of bet images displayed to the sub monitor 113.

FIG. 7 is a view schematically showing an example of bet images displayed to the sub monitor. The bet image displayed to the screen of the sub monitor 113 covered by the touch panel 114 is provided with: a horse number display region 201; a horse name display region 202; a basic ability display region 203 displaying speed and stamina by means of bar charts; a record display region 204 displaying orders of finish in last five races; a condition display region 205 displaying current conditions by means of arrows; and a betting ticket purchase button display region 206 displaying, with odds and number of bets, a betting ticket perchance button for quinella in which a combination of horse numbers that will finish first and second in any order is predicted.

Further, the bet image includes images of a help button 211, a 1-bet button 213, a 5-bet button 214, a 10-bet button 215, a 50-bet button 216, a cancel button 217, a cash-out button 218, and a betting ticket system switch button 222.

Moreover, the bet image is provided with a time display region 212, a number-of-bets display region 219, an amount-of-payout display region 220, and a number-of-credits display region 221.

The help button 211 is a button to be touched by the player for displaying an operation method for betting and the like to the sub monitor 113. In the time display region 212, remaining time possible for bet-input is displayed. The 1-bet button 213 is a button to be touched by the player for adding “1” to the current number of bets. The 5-bet button 214 is a button to be touched by the player for adding “5” to the current number of bets. The 10-bet button 215 is a button to be touched by the player for adding “10” to the current number of bets. The 50-bet button 216 is a button to be touched by the player for adding “50” to the current number of bets.

The cancel button 217 is a button to be touched by the player for cancelling the added number of bets. The cash-out button 218 is a button to be touched by the player for paying out coins in number in accordance with the number of credits owned by the player by means of the ticket 39 with a barcode. In the number-of-bets display region 219, the total number of bets set by the player in the current race is displayed. The amount-of-payout display region 220 displays an amount of payout in the race this time around. In the number-of-credits display region 221, the number of credits owned by the player is displayed.

Although the bet image shown in FIG. 7 is the quinella bet image, every time a betting ticket system switch button 222 is touched, the bet image is switched to win, place, exacta, trifecta, bracket quinella, trio, quinella-place (wide), and the like.

The player touches any of the 1-bet button 213, the 5-bet button 214, the 10-bet button 215, and the 50-bet button 216, and then touches any betting ticket purchase button within the betting ticket purchase button display region 206, so as to place a bet. For example, when touching the 10-bet button 215 and then touching a “1-2” betting ticket purchase button within the betting ticket purchase button display region 206, the player can add “10” to the current number of bets on “1-2”. Here, “1-2” means that a combination of No. 1 horse and No. 2 horse will take first and second place in any order. It is to be noted that the current number of bets on each combination of horse numbers is displayed next to the betting ticket purchase button corresponding to each combination.

Returning to FIG. 6, in step S13, the CPU 131 specifies contents of the bet operation performed by the player based on a coordinate signal from the touch panel driving circuit 122, and stores the contents into the RAM 132. Further, The CPU 131 reflects the contents of the bet operation to the display on the bet image of the sub monitor 113.

In step S14, the CPU 131 determines whether or not the bet operation has been performed. When determining that the bet operation has not been performed, the CPU 131 returns the processing to step S13. On the other hand, when determining that the bet operation has been performed, the CPU 131 shifts the processing to step S15.

In step S15, the CPU 131 transmits bet information showing the contents of the bet operation as a bet information signal to the main control portion 12 through the communication interface 125. It is to be noted that the bet information signal includes at least an ID of a racehorse on which the bet has been placed, the number of bet game media, information regarding the type of a betting ticket, and an identification number of the station 101.

In step S16, the CPU 131 determines whether or not the elapsed time tt measured by the timer 126 has reached previously set specified time TT (e.g. 60 seconds). When determining that the elapsed time tt has not reached the specified time TT, the CPU 131 returns the processing to step S13. On the other hand, when determining that the elapsed time tt has reached the specified time TT, the CPU 131 shifts the processing to step S17.

In step S17, based on payout information transmitted from the main game portion 11, the CPU 131 updates the number of credits owned by the player which is stored in the RAM 132, and also updates display in the amount-of-payout display region 220 and the number-of-credits display region 221 on the bet image of the sub monitor 113.

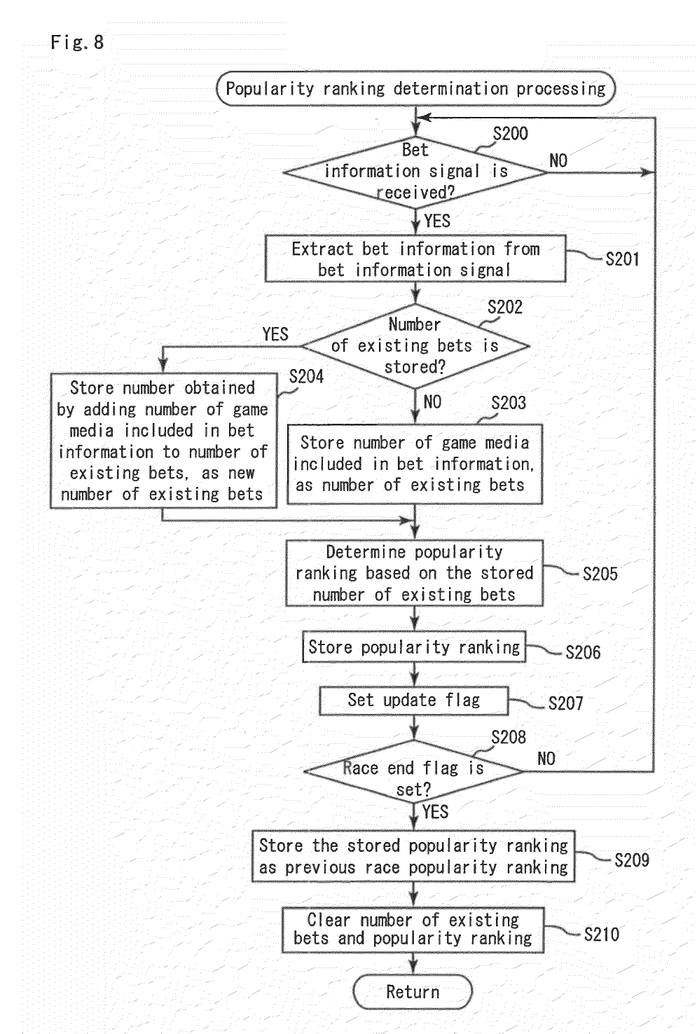

FIG. 8 is a flowchart showing a subroutine of popularity ranking determination processing performed in the main game portion.

The popularity ranking determination processing shown in FIG. 8 is processing read and executed at prescribed timing separately from the game operation processing shown in FIG. 6.

First, in step S200, the CPU 41 determines whether or not a bet information signal has been received from the CPU 131. When determining that the bet information signal has not been received, the CPU 41 returns the processing to step S200. On the other hand, when determining that the bet information signal has been received, the CPU 41 shifts the processing to step S201.

In step S201, the CPU 41 extracts bet information from the received bet information signal. Next, the CPU 41 determines whether or not the number of existing bets has been stored in the RAM 42 in association with the racehorse ID included in the bet information (step S202).

Here, the number of existing bets is a numeric value showing the number of game media having already been bet on a racehorse to run in the race this time around.

In step S202, when determining that the number of existing bets has not been stored, the CPU 41 stores the number of game media included in the bet information as the number of existing bets into the RAM 42 in association with the racehorse ID included in the bet information (step S203).

For example, in the case of the win betting ticket system, the very number of game media bet on the racehorse is stored as the number of existing bets. Further, in the case of the quinella betting ticket system, a total number of game media bet with the betting ticket may be taken as the number of existing bets on each of the racehorses predicted to take first and second place with the betting ticket, or the half of the game media bet with the betting ticket may be taken as the number of existing bets on each of the racehorses predicted to take first and second place with the betting ticket. Meanwhile, in the case of the exacta betting ticket system, the total number of game media bet with the betting ticket may be taken as the number of existing bets on each of the racehorses predicted to take first and second place with the betting ticket, or the half of the game media bet with the betting ticket may be taken as the number of existing bets on each of the racehorses predicted to take first and second place with the betting ticket; or, the number of game media may be divided at a ratio of 7:3 and the respective divided numbers of game media may be taken as the numbers of existing bets on the racehorses predicted to take first and second place with the betting ticket.

In step S202, when determining that the number of existing bets has been stored, the CPU 41 stores in the RAM 42 a figure obtained by adding the number of game media included in the bet information to the number of existing bets stored in the RAM 42 in association with the racehorse ID included in the bet information, as the new number of existing bets, in association with the racehorse ID (step S204). It is to be noted that as in the case of step S103, depending on the type of the betting ticket system, the very number of game media included in the bet information may be added to the number of existing bets, the half of the number of game media may be added to the number of existing bets, or the number of game media divided at a prescribed ratio may be added to the number of existing bets.

The CPU 41 compares the numbers of existing bets stored in the RAM 42 in association with the IDs of the respective racehorses provided with the starting numbers of “1” to “6”, and determines a popularity ranking in decreasing order of number of existing bets (step S205). The CPU 41 then stores the popularity ranking determined in step S205 into the RAM 42 (step S206). Further, the CPU 41 sets an update flag (step S207).

In step S208, the CPU 41 determines whether or not a race end flag has been set. When determining that the race end flag has not been set, the CPU 41 shifts the processing to step S200. On the other hand, when determining that the race end flag has been set, the CPU 41 shifts the processing to step S209.

In step S209, the CPU 41 stores into the external storage device 25 the popularity ranking stored in the RAM 42, as the previous race popularity ranking in association with the racehorse IDs and the race No. The CPU 41 then clears the number of existing bets and the popularity ranking which are stored in the RAM 42 (step S210), and completes the present subroutine.

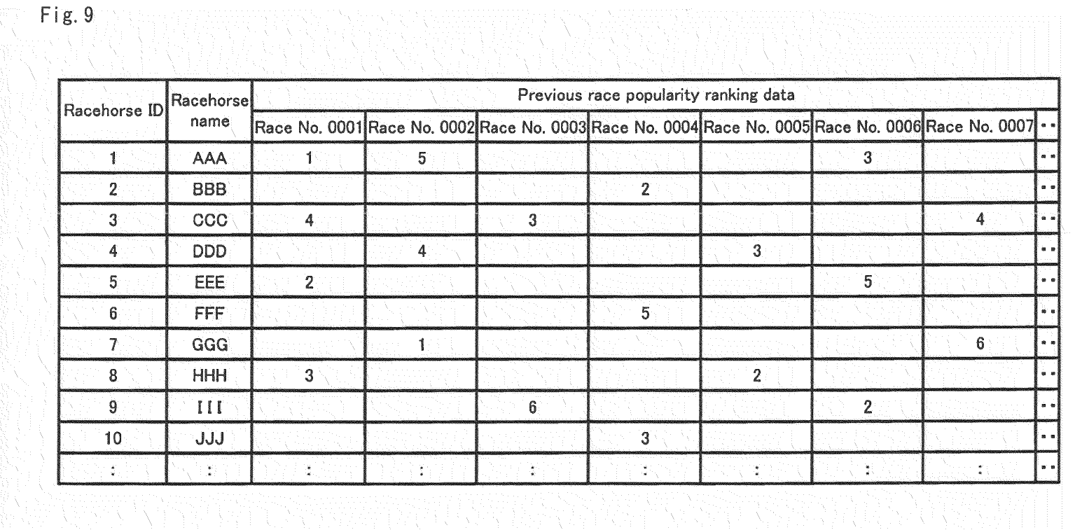

FIG. 9 is a view showing an example of previous race popularity ranking tables stored in the external storage device.

In the previous race popularity ranking table, names of racehorses and previous race popularity ranking data are stored in association with the racehorse IDs.

In the previous race popularity ranking data, a popularity ranking of each racehorse in each race is stored in association with the racehorse ID. For example, in a race of race No. 0001, a racehorse ID 1 is ranked first, a racehorse ID 5 is ranked second, a racehorse ID 8 is ranked third, and a racehorse ID 3 is ranked fourth. Further, the race No. is a number provided to a racing game in each play of the racing game, and a larger number means a racing game played more recently.

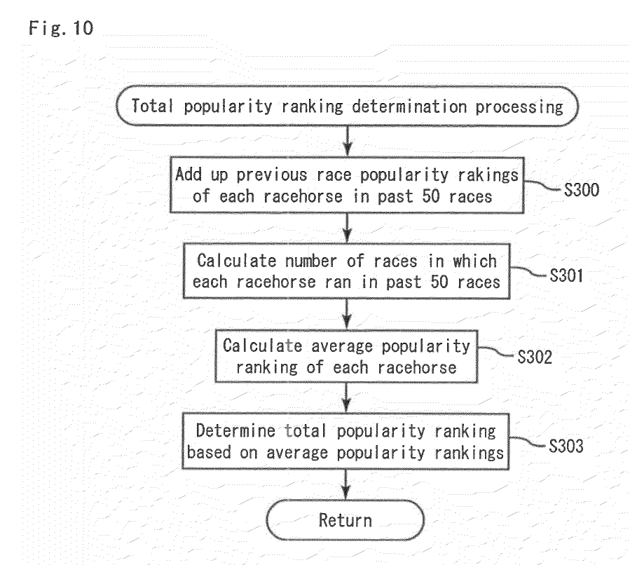

FIG. 10 is a flowchart showing a subroutine of total popularity ranking determination processing performed in the main game portion.

First, the CPU 41 adds up the previous race popularity rankings of each racehorse in past 50 racing games up to a previous racing game (step S300). For example, when the largest race No. of the previous race popularity ranking data stored in the previous race popularity ranking table is 0178, the previous race popularity rankings of each racehorse in racing games of race No. 0129 to 0178 are added up.

Next, the CPU 41 calculates the number of running races of each racehorse in the past 50 racing games up to the previous racing game (step S301). For example, when the largest race No. of the previous race popularity ranking data stored in the previous race popularity ranking table is 0178, the number of racing games in which each racehorse ran, out of the racing games of race No. 0129 to 0178, is calculated.

The CPU 41 divides the added-up previous race popularity ranking obtained in step S300 by the number of running races calculated in step S301, to calculate an average popularity ranking of each racehorse (step S302). The CPU 41 then determines a total popularity ranking from the top in increasing order of calculated value for average popularity ranking (step S303). Namely, a racehorse with the smallest value of the average popularity ranking is ranked first in the total popularity ranking.

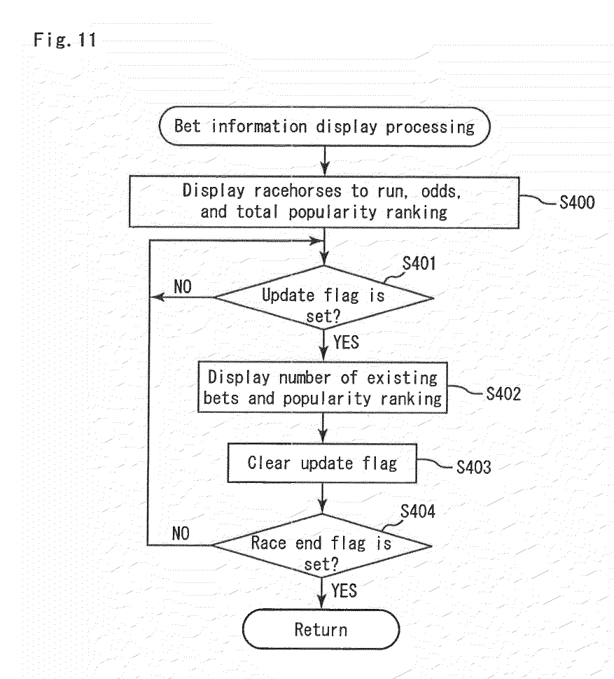

FIG. 11 is a flowchart showing a subroutine of bet information display processing performed in the main game portion.

First, under control of the CPU 41, the VDP 315 produces respective images showing the total popularity ranking, names of racehorses to run and odds thereof which have been determined in the processing of steps S100, S101 and S103, based on the dot data, the background image data and the like which are stored in the image ROM 312. The CPU 41 then controls the VDP 315, to output the produced images to the main monitor 21 (step S400).

By the processing of step S400, the image showing the names of the racehorses to run is displayed in the horse name display region 4 of the bet information image 2, and the image showing the odds is displayed in the odds display region 5 of the bet information image 2. Further, the image showing the total popularity ranking is displayed in the total popularity ranking display region 8 of the bet information image 2. It is to be noted that the image showing a total popularity ranking corresponds to the image showing information based on bets in the present invention.

Next, in step S401, the CPU 41 determines whether or not an update flag has been set. When determining that the update flag has not been set, the CPU 41 returns the processing to step S401. On the other hand, when determining that the update flag has been set, the CPU 41 shifts the processing to step S402.

In step S402, under control of the CPU 41, the VDP 315 produces respective images showing the number of existing bets and the popularity ranking of each racehorse which are stored in the RAM 42, based on the dot data, the background image data, and the like which are stored in the image ROM 312. The CPU 41 then controls the VDP 315, to output the produced images to the main monitor 21. By the processing of step S402, the image showing the number of existing bets is displayed in the betting state display region 7 of the bet information image 2, and the image showing the popularity ranking is displayed in the popularity ranking display region 6 of the bet information image 2. It is to be noted that the image showing the numbers of existing bets and the image showing the popularity ranking correspond to the image showing information based on bets in the present invention.

Next, in step S403, the CPU 41 clears the update flag. Further, in step S404, the CPU 41 determines whether or not a race end flag has been set. When determining that the race end flag has not been set, the CPU 41 returns the processing to step S401. On the other hand, when determining that the race end flag has been set, the CPU 41 completes the present subroutine.

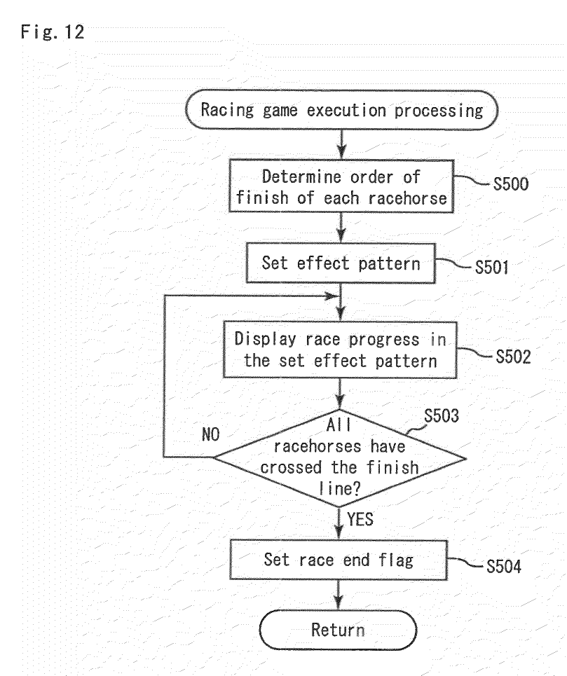

FIG. 12 is a flowchart showing a subroutine of racing game execution processing performed in the main game portion.

First, in step S500, the CPU 41 determines an order of finish of each racehorse in the racing game, based on random numbers generated by the random number generator 35.

In step S501, the CPU 41 sets an effect pattern for image display, based on the order of finish of each racehorse determined in the processing of step S500. Under control of the CPU 41, the VDP 315 produces an effect image of each racehorse from the start to the finish based on the background image data, the image data of the racehorses, and the like which are stored in the image ROM 312.

In step S502, the CPU 41 controls the VDP 315 so as to display the effect image (image showing a race process) produced in the processing of step S501, to the main monitor 21.

Next, in step S503, the CPU 41 determines whether or not all the racehorses running in the racing game have crossed the finish line. When determining that all the racehorses have not crossed the finish line, the CPU 41 shifts the processing to step S502. On the other hand, when determining that all the racehorses have crossed the finish line, the CPU 41 shifts the processing to step S504.

In step S504, the CPU 41 sets the race end flag. It should be noted that the race end flag is a flag to be set at the end of the race and cleared when racehorses to run in a next race are determined. After the processing of step S504, the present subroutine is completed.

As described above, according to the horse racing game apparatus 1 of the present embodiment, when a bet on a racehorse to run in a racing game is inputted by the player through the input device, an image showing information based on the bet is displayed to the image display.

Therefore, the player who plays a game on the horse racing game apparatus 1 can make a prediction by using information based on bets of other players as information for making a decision. This allows any player to easily make a prediction while enjoying a game by, for example, betting on the same racehorse as another player as taking it that his or her prediction will prove correct, or venturing to place a bet on a different racehorse from those on which other players have placed bets.

Further, information based on bets constantly changes in accordance with a betting state. It is therefore possible to let the player play a game without feeling bored, by making the player playing a game on the horse racing game apparatus 1 pay attention to the constantly changing information.

Further, it is also possible to make a player having already placed a bet pay attention to the constantly changing information, and reconsider the bet already placed or have an incentive to further place a bet, as triggered by actions of other players.

Further, when another player places a bet on the same racehorse as the racehorse on which the player has placed a bet, it is possible to make the player have sympathy with this player for making the same prediction as the player has made. Moreover, it is possible to make the player feel superior when many players place bets on the same racehorse after the player has placed a bet on the racehorse.

Further, it is possible to make the players having made the same prediction have a sense of togetherness at the end of the racing game. Moreover, when the prediction of only one player proves correct, it is possible to make the player feel superior.

As just described, the player can see cards of the other players and thus use strategy or have a sense of togetherness with players around him or her, whereby the vibrancy in the gaming parlor can be enhanced.

In the present embodiment, the case has been described where racehorses to run are determined based on random numbers generated by the random number generator 35. However, in the present invention, racehorses may be made to run in sequential order. For example, racehorses may be made to run in a racing game in order of racehorse ID. Further, racehorses may be divided into groups each consisting of a prescribed number of (e.g. 6) racehorses, and made to run in the unit of groups in order of group.

In the present embodiment, the case has been described where an image showing information based on bets is displayed to the main monitor 21. However, in the present invention, an image may be displayed to the sub monitor.

In the present embodiment, the case of determining a popularity ranking based on the number of game media bet on each racehorse has been described. However, in the present invention, a popularity ranking may be determined based on the number of players who have placed a bet on each racehorse. Namely, a racehorse on which a larger number of players have placed a bet may have a higher popularity ranking.

In the present embodiment, the case has been described where one racecourse is stored in the ROM 43. However, in the present invention, a plurality of racecourses may be stored in the ROM; for example, a dirt course, a turf course, a clockwise course, a counter-clockwise course, courses having different race distances, and the like may be stored in the ROM.

Specifically, the CPU 41 selects one racecourse out of a plurality of racecourses stored in the ROM 43 based on a random number generated by the random number generator 35, and takes the selected racecourse as a course of the race this time around. Further, the CPU 41 transmits to each station 101 the selected racecourse as race information, along with racehorses to run and odds thereof which have been determined in the processing of steps S100 and S101.

In the present embodiment, the case has been described where a total popularity ranking is determined based on previous race popularity rankings in past 50 racing games up to a previous racing game, which are stored in the previous race popularity ranking table. However, in the present invention, a new total popularity ranking may be calculated by using a prescribed calculation formula, based on a total popularity ranking determined in the previous racing game and on the previous race popularity ranking in the previous racing game. Namely, a total popularity ranking can be determined without referring to the previous race popularity rankings in games before the previous race. This eliminates the need for storing vast amounts of data in the external storage device 25 in order to determine a total popularity ranking in a case where the number of racing games becomes large.

In the present embodiment, the case has been described where a total popularity ranking is determined based on previous race popularity rankings in past 50 racing games up to a previous racing game, which are stored in the previous race popularity ranking table. However, in the present invention, a total popularity ranking may be determined based on an average number of bets per race in past 50 racing games up to the previous racing game.

Specifically, the number of game media bet on each racehorse in each race is stored in the previous race popularity ranking table in association with a racehorse ID.

First, the CPU 41 adds up the numbers of game media bet on each racehorse in past 50 racing games up to the previous racing game. Next, the CPU 41 calculates the number of running races of each racehorse in past 50 racing games up to the previous racing game. Further, the CPU 41 divides the added-up number of game media by the calculated number of running races, to calculate an average number of bets on each racehorse per race. The CPU 41 then determines a total popularity ranking in decreasing order of calculated average number of bets on the racehorses.

In the present embodiment, the case has been described where a prescribed number of racing games in determination of a total popularity ranking is 50 racing games, but in the present invention, the prescribed number of racing games may be arbitrarily selected.

In the present embodiment, the case of determining a total popularity ranking without consideration of the type of a racecourse has been described. However, in the present invention, a total popularity ranking may be determined based on only previous race popularity rankings in the same type of racecourses as a racecourse currently accepting bet-input.

For example, in a case where a racecourse currently accepting bet-input is a clockwise turf course with a race distance of 2000 m and a good riding ground state, a total popularity ranking is determined based on only race popularity rankings in races with completely the same racecourse conditions.

Specifically, in previous race popularity ranking data, a popularity ranking of each racehorse in each race is stored in association with a racehorse ID and the type of a racecourse. The CPU 41 adds up previous race popularity rankings of each racehorse in racecourses with the same conditions as those of a racecourse currently accepting bet-input. Next, the CPU 41 calculates the number of running races of each racehorse in the racecourse with the same conditions as those of the racecourse currently accepting bet-input. Further, the CPU 41 divides the added-up previous race popularity ranking by the calculated number of running races, to calculate an average popularity ranking of each racehorse. The CPU 41 then determines a total popularity ranking from the top in increasing order of calculated value for average popularity ranking of the racehorses.

Moreover, in the case of a racecourse currently accepting bet-input being a clockwise turf course with a race distance of 2000 m and a good riding ground state, a total popularity ranking may be determined for each of the conditions of the clockwise, the turf course, the race distance of 2000 m, and the good riding ground state. The determined total popularity rankings of the four types may be simultaneously displayed to the image display, or each total popularity ranking may be displayed in sequential order at regular time intervals.

Furthermore, when it is configured that an image showing information based on bets is displayed to the sub monitor, whether all total popularity rankings are simultaneously displayed or only a total popularity ranking arbitrarily selected by the player is displayed may be determined by operation of the player.

In the present embodiment, the case has been described where the number of game media bet on each racehorse is displayed to the image display by means of a bar chart. However, in the present invention, the number of game media may be displayed by a figure.

With such a configuration, since the very number of game media bet on each race object is displayed, the player can see the very numbers of game media bet by other players. It is thus possible to make the player having seen the displayed numbers of game media feel like betting more game media than other players. In this manner, it is possible to enhance a sense of rivalry of each player, so as to increase the number of game media bet per racing game.

Further, it is possible to make the player think that a race object on which many game media have been bet has a high possibility to win, and thus have an incentive to bet game media on the race object.

In the present embodiment, the case of displaying the number of game media bet on each racehorse to the image display has been described. However, in the present invention, a ratio of game media bet on each race object may be displayed to the image display.

Specifically, the CPU 41 adds up the numbers of existing bets stored in the RAM 42 in association with the IDs of respective racehorses provided with starting numbers of “1” to “6” in step S100, to calculate a total number of bets. Next, the CPU 41 divides the number of existing bets stored in the RAM 42 in association with each racehorse ID by the total number of bets, to calculate a ratio of game media bet on each racehorse. Subsequently, under control of the CPU 41, the VDP 315 produces an image showing the calculated ratio of game media, based on the dot data, the background image data, and the like, which are stored in the image ROM 312. The CPU 41 then controls the VDP 315, to output the produced image to the main monitor 21.

With such a configuration, since display is made in such a mode that other player's betting states are highly easy to see, the player can easily understand information. Namely, for example, when such ratios are displayed that the numbers of game media bet on respective race objects are almost the same, it is possible to determine that the popularities of the respective race objects in the race are nearly equal, and to predict that the race will be a confused race. Further, when only a ratio of a certain race object is displayed high, it is possible to determine that the race object is popular in the race, and to predict that the race object may win an overwhelming victory.

In the present embodiment, the case of applying the present invention to the horse racing game apparatus 1 has been described, but in the present invention, a bike racing game apparatus, a boat racing game apparatus, a dog racing game apparatus, a car racing game apparatus, a motorcycle racing game apparatus, or the like may be adopted. In the case of forming such a configuration, bikes, motorboats, dogs, cars, or motorcycles correspond to the race objects in the present invention.

Although the embodiment of the present invention has been described above, it just presents a specific example, and does not particularly limit the present invention. A specific configuration of each unit or the like can be appropriately changed in terms of design. Further, the description of the effects made in the embodiment of the present invention are only recitation of the most preferable effects that arise from the present invention, and the effects according to the present invention are not limited to those described in the embodiment of the present invention.

What is claimed as new and desired to be secured by Letters Patent of the United States is:

1. A gaming apparatus, comprising:
an image display capable of displaying an image;
an input device with which a plurality of players can input a bet on race objects that participate in a racing game in which a plurality of race objects contend with one another for winning; and
a controller,
said controller programmed so as to execute the processing of
(A) proceeding with said racing game, and
(B) displaying to said image display an image showing information based on bets inputted from said input device before the end of the racing game executed in said processing (A).

2. The gaming apparatus according to claim 1,
wherein
said controller is further programmed so as to execute the processing of
(C) determining a popularity ranking of each race object, based on the bets inputted from said input device, and
said processing (B) includes the processing of
(B-1) displaying to said image display an image showing the popularity ranking determined in said processing (C).

3. The gaming apparatus according to claim 2,
wherein
said controller is further programmed so as to execute the processing of
(D) counting game media bet on each race object, based on the bets inputted from said input device, and
said processing (C) is the processing of
determining a popularity ranking of each race object, based on the number of game media counted in said processing (D).

4. The gaming apparatus according to claim 1,
wherein
said controller is further programmed so as to execute the processing of
(D) counting game media bet on each race object, based on the bets inputted from said input device, and
said processing (B) includes the processing of
(B-2) displaying to said image display an image showing the number of game media bet on each race object which has been counted in said processing (D).

5. The gaming apparatus according to claim 1,
wherein
said controller is further programmed so as to execute the processing of
(D) counting game media bet on each race object, based on the bets inputted from said input device, and
said processing (B) includes the processing of
(B-3) displaying to said image display an image showing a ratio of game media bet on each race object, based on the number of game media bet on each race object which has been counted in said processing (D).

6. The gaming apparatus according to claim 1,
wherein
said controller is further programmed so as to execute the processing of
(C) determining a popularity ranking of each race object, based on the bets inputted from said input device, and
(E) determining a total popularity ranking showing a popularity ranking of each race object throughout racing games in a prescribed number up to a previous racing game, based on the popularity ranking of each race object which has been determined in said processing (C), and
said processing (B) includes the processing of
(B-4) displaying to said image display an image showing the total popularity ranking determined in said processing (E).

7. A game control method, including the steps of:
(A) proceeding with a racing game in which a plurality of race objects contend with one another for winning; and
(B) displaying, to an image display capable of displaying an image, an image showing information based on bets that have been inputted from an input device with which a plurality of players can input a bet, before the end of the racing game executed in said step (A), on the race objects that participate in said racing game.

8. The game control method according to claim 7, the method including the step of
(C) determining a popularity ranking of each race object, based on the bets inputted from said input device,
wherein
said step (B) includes the step of
(B-1) displaying to said image display an image showing the popularity ranking determined in said step (C).

9. The game control method according to claim 8, the method including the step of
(D) counting game media bet on each race object, based on the bets inputted from said input device,
wherein
said step (C) is the step of
determining a popularity ranking of each race object, based on the number of game media counted in said step (D).

10. The game control method according to claim 7, the method including the step of
(D) counting game media bet on each race object, based on the bets inputted from said input device,
wherein
said step (B) includes the step of
(B-2) displaying to said image display an image showing the number of game media bet on each race object which has been counted in said step (D).

11. The game control method according to claim 7, the method including the step of
(D) counting game media bet on each race object, based on the bets inputted from said input device,
wherein
said step (B) includes the step of
(B-3) displaying to said image display an image showing a ratio of game media bet on each race object, based on the number of game media bet on each race object which has been counted in said step (D).

12. The game control method according to claim 7, the method including the step of
(C) determining a popularity ranking of each race object, based on the bets inputted from said input device,
(E) determining a total popularity ranking showing a popularity ranking of each race object throughout racing games in a prescribed number up to a previous racing game, based on the popularity ranking of each race object which has been determined in said step (C),
wherein
said step (B) includes the step of
(B-4) displaying to said image display an image showing the total popularity ranking determined in said step (E).
